(19) United States
(12) Patent Application Publication
(10) Pub. No.: US 2023/0014039 A1
(43) Pub. Date: Jan. 19, 2023

(54) CUTTING DEVICE FOR CHOPPING FOOD PRODUCTS AND FOOD PREPARATION APPLIANCE

(71) Applicant: VORWERK & CO. INTERHOLDING GMBH, Wuppertal (DE)

(72) Inventors: Andreas Heynen, Radevormwald (DE); Kai Landsecker, Düsseldorf (DE); Maria Diel, Leichlingen (DE)

(21) Appl. No.: 17/852,130

(22) Filed: Jun. 28, 2022

(30) Foreign Application Priority Data
Jul. 14, 2021 (EP) 21185463.3

(51) Int. Cl. B26D 1/29

(52) U.S. Cl. CPC B26D 1/29

(57) ABSTRACT

A cutting device for chopping food products with a cutting disc with friction and/or cutting elements. The cutting device includes a shaft for the cutting disc. The cutting disc is attached to the shaft or can be detachably attached to the shaft, with a filling neck, via which food products can be fed to the cutting disc.

### CROSS-REFERENCE TO RELATED APPLICATION

This application claims benefit of European Application No. 21185463.3, filed on Jul. 14, 2021, the disclosure of which is hereby incorporated in its entirety by reference herein.

### TECHNICAL FIELD The present disclosure relates to a cutting device for chopping food products.

### BACKGROUND

A food preparation appliance is an appliance for a kitchen, i.e. a kitchen appliance. The food preparation appliance comprises a preparation vessel in which the food can be prepared. The food preparation appliance may comprise a lid for the preparation vessel. The food preparation appliance may comprise a locking device for locking the lid when the lid is placed on the preparation vessel. The food preparation appliance may comprise a sensor which is triggered when the locking device locks the lid in place. The food preparation appliance comprises the cutting device.

A kitchen appliance with a cutting device is known from the publication EP 3 427 621 A1. The cutting device comprises a rotatable cutting disc with which a food product can be chopped.

Electrically operated kitchen appliances with a preparation vessel and a lid for the preparation vessel are known from the publications DE 10 2014 111 193 A1 and DE 10 2017 121 946 A1.

### SUMMARY

The present disclosure is directed to a cutting device with which chopping can be performed particularly uniformly.

The cutting device comprises a rotatable cutting disc with friction and/or cutting elements. The cutting disc is basically a circular body whose radius is many times greater than its thickness. For stability reasons, the cutting disc basically consists of metal. Cutting elements of the cutting disc comprise sharp edges for cutting food products. Friction elements can be protruding teeth or pins. The teeth or pins may be pointed and/or sharp-edged.

The cutting disc is attached to a shaft or can be detachably attached to the shaft. In order to save space without great effort when storing the cutting device, the cutting disc can preferably be detached from the shaft without having to use tools. The shaft may consist of plastic to keep the manufacturing costs and weight low.

The cutting device comprises a filling neck via which a food product can be fed to the cutting disc. If a food product is fed to the cutting disc via the filling neck and the cutting disc rotates, the fed food product is chopped.

The filling neck comprises two chutes. A food product can be fed to the cutting disc via each chute. The two chutes are separated from each other by a partition (dividing wall).

The partition is basically closed and basically has a smooth surface. The wall of the filling neck is also basically closed. At least the inside of the wall of the filling neck is preferably smooth. Smooth walls allow a food product to pass through each chute as unhindered as possible. Closed walls prevent a food product from leaving a chute unintentionally through side openings.

### BRIEF DESCRIPTION OF THE DRAWINGS

The figuresshow:

FIG. 1 illustrates a pressing means of a cutting device;

FIG. 2 illustrates a cover with filling neck of the cutting device;

FIG. 3 illustrates a cover with filling neck and pressing means;

FIG. 4 illustrates a plan view to cover and filling neck;

FIG. 5 illustrates a cutting disc with centrifugal effect;

FIG. 6 illustrates a vessel of the cutting device;

FIG. 7 illustrates shaft of the cutting device;

FIG. 8 illustrates a food processor with lid part;

FIG. 9 illustrates a food processor with interior view into the preparation vessel;

FIG. 10 illustrates a food processor with cutting device;

FIG. 11 illustrates a plan view on cover when cutting disc is rotated clockwise;

FIG. 12 illustrates a plan view on cover when cutting disc is rotated counterclockwise;

FIG. 13 illustrates a cover with filling neck according to a further embodiment;

FIG. 14 illustrates a cover with filling neck according to a further embodiment; and

FIG. 15 illustrates a cutting disc without centrifugal effect.

### DETAILED DESCRIPTION

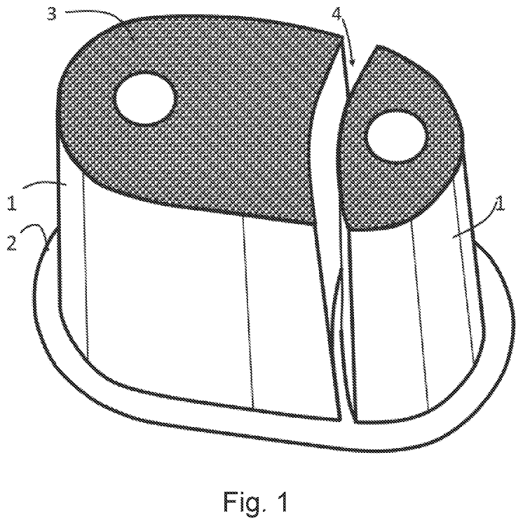

FIG. 1 shows a pressing means, namely a view of the lower side of two plungers 1 of the pressing means. The two plungers 1 are firmly connected to each other on their upper side by a circumferential edge 2. The edge 2 protrudes laterally. Each plunger 1 can also be designed as a vessel, for example as a measuring cup. The base of one or two plungers 1 may each have an opening. A vessel-like plunger 1 with an opening in the base can then be used to supply a liquid via the plunger 1. On the lower side, both plungers 1 can have protruding knobs 3 which are intended to fix a food product. The knobs 3 can, for example, be tapered outwards in a cone shape in order to hold a food product without slippage during feeding and thus stabilize the alignment during feeding. Between the two plungers 1 there is a gap 4 as shown in FIG. 1, which, when viewed in plan view, extends in an arcuate shape and therefore has an indentation. The gap 4 widens outwards, i.e. in the case of FIG. 1 towards the top.

The two plungers 1 have different shapes and sizes when viewed in plan view. The height of the two plungers 1 is the same.

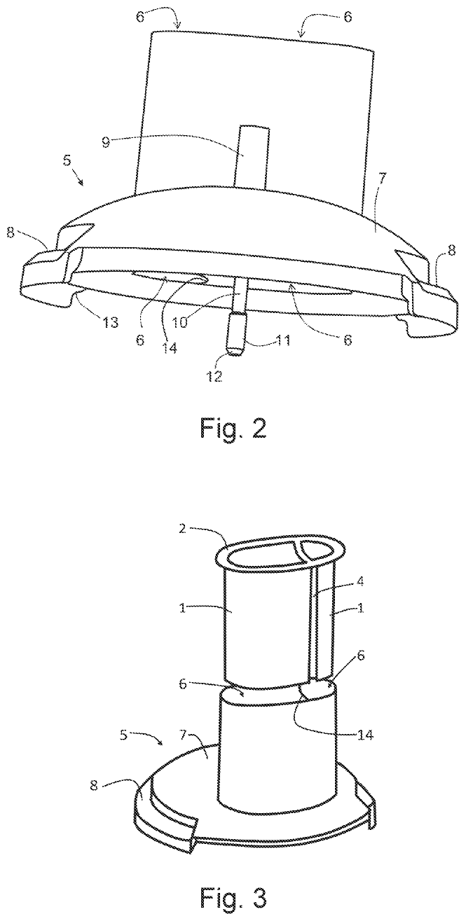

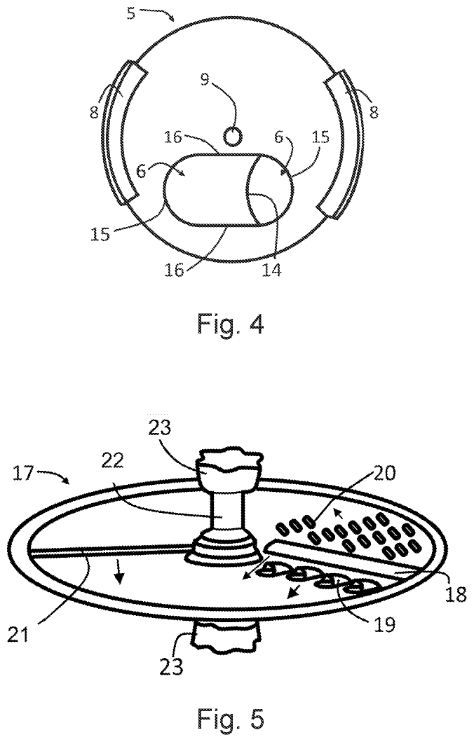

FIG. 2 shows a cover 5 of the cutting device. The cover 5 comprises two chutes 6, which are formed by an upwardly protruding filling neck with an inner partition 14. The cover 5 is thus an example of a component with a filling neck. The chutes 6 are adapted to the two plungers 1 in such a way that the plungers 1 can be inserted into the two chutes 6. The laterally protruding edge 2 prevents the plungers 1 from falling through the chutes 6. By means of the plungers 1, a food or an ingredient of a food can be pressed through the chutes 6 against a cutting disc with cutting elements shown in FIG. 4.

The chutes 6 and the filling neck are connected at their lower side to a curved cap 7 in an edge region of the cap 7. On the lower side of the cap 7, part-circular steps 8 are provided on two opposite sides. The two part-circular steps 8 protrude laterally and downwardly from the cap 7.

A mandrel 9 protrudes upwardly from the cap 7 from approximately the center of the cap 7. The mandrel 9 retains a rod 10 protruding downwardly relative to the cap 7. The outer diameter of the mandrel 9 is larger than the maximum outer diameter of the rod 10 for stability reasons. The rod 10 may have a cylindrical widening 11 at its free end with a tapering free end 12. The lower side of the steps 8 may be designed as a hook shape 13.

In FIG. 3, a rotated view of the cover 5 is shown compared to FIG. 2, and also the pressing means with the two plungers 1 ready for insertion above the two chutes 6. The two chutes 6 are separated by the partition 14, which in plan view runs in an arcuate shape, namely in a part-circle shape.

When the two plungers 1 are inserted into the chutes 6, the pressing means is held in a clamped manner in the end position. This is achieved because the width of the gap 4 tapers towards the circumferential edge 2 and the thickness of the partition 14 is selected such that the partition can finally be held frictionally through the gap 4, The frictional connection is just large enough to prevent the filling neck from falling out of the cover 5 when the cover 5 is turned around. If the cover 5 is released after chopping, the pressing means can then advantageously not fall out of the chutes 6 in an unplanned manner. Producing the tapered shape is possible by injection molding. and this can also be done by taking advantage of warpage that can occur during injection molding. However, a suitable taper can still be produced following injection molding.

In FIG. 3, it can be seen that the two plungers 1 have openings on the upper side and are consequently each designed as a vessel when the base of the plungers 1 is closed.

In FIG. 4, a plan view of the cover 5 is shown, showing the semi-circular course of partition 14. It can also be seen that the oval filling neck is formed from two semicircular end faces 15 and two parallel walls 16. The part-circular partition 14 adjoins the part-circular end face 15, Thus, there is a larger chute 6 when viewed in plan view and a much smaller chute 6 when viewed in plan view. The inlet opening of the large chute 6 can be at least twice as large as the inlet opening of the small chute 6 in order to be able to feed food products of different sizes in a suitable manner. The mandrel 9 is located in the center of the cover 5. The two chutes 6 are located next to the mandrel 5 and thus next to the center of the cover 5. From this follows that the two chutes 6 are arranged off-center with respect to the shaft that food can be pressed against the partition by the rotating cutting disk.

FIG. 5 shows a cutting disc 17 of the cutting device. On the lower side at the slot 18, there is a blade running parallel to the slot 18. The cutting direction of the blade is indicated by an arrow. The blade at slot 18 protrudes downwardly from the cutting disc 17. Seen in the cutting direction, the slot 18 and thus also the cutting edge of the blade form an angle of less than 90° with the outer edge of the cutting disc 17. This ensures that a food product to be chopped is increasingly conveyed towards the outer edge of the cutting disc 17 during chopping. The downwardly protruding blade thus acts centrifugally on a food product due to its arrangement when the downwardly protruding blade chops a food product.

There are hood-shaped cutting elements 19 with an arcuate blade for cutting strips. The hood-shaped cutting elements 19 protrude upwards from the cutting disc 17. Below each hood-shaped cutting element 19 there is a hole leading through the cutting disc, which is passed by a chopped food product. In FIG. 5, four such hood-shaped cutting elements 19 are shown by way of example. The hood-shaped cutting elements 19 are arranged in a row as shown in FIG. 5 in such a way that this row forms an angle of less than 90° with the outer edge. As a result, a food product to be chopped is increasingly conveyed in the direction of the outer edge during the chopping process, as indicated by an arrow. The upwardly protruding cutting elements 19 thus act centrifugally on a food product due to their arrangement when the upwardly protruding cutting elements 19 chop a food product.

There are further a plurality of holes 20. For example, there may be 17 such holes 20 as shown in FIG. 5. Below each hole 20 there is a hood-shaped cutting element which protrudes downwardly from the cutting disc 17. The cutting direction of the downwardly protruding arcuate cutting elements is indicated by an arrow. The arrangement of the holes 20 is such that, viewed in the cutting direction, there are holes 20 at the outer edge which are offset backwards relative to holes at the shaft 22. This ensures that a food product to be chopped is increasingly conveyed in the direction of the outer edge of the cutting disc 17 during chopping. In addition, holes 20 are arranged next to each other in such a way that a row formed thereby encloses an angle smaller than 90° with the outer edge of the cutting disc 17, as can be seen in FIG. 5. This additionally ensures that a food product to be chopped is increasingly conveyed towards the outer edge of the cutting disc 17 during chopping. The downwardly protruding cutting elements thus act centrifugally on a food product due to their arrangement and alignment when the downwardly protruding cutting elements chop a food product.

The hood-shaped cutting elements protruding downwards from the cutting disc 17 are smaller than the hood-shaped cutting elements 19 protruding upwards from the cutting disc 17. This allows strips of different sizes to be cut from a food product.

The cutting disc 17 comprises a blade 21 which protrudes obliquely upwards from the cutting disc 17. The cutting direction is indicated by an arrow. Below the blade 21 there is a slot through which the chopped food product passes. Seen in the cutting direction, the blade 21 forms an angle of less than 90° with the outer edge of the cutting disc 17. As a result, a food product to be chopped is increasingly conveyed towards the outer edge during chopping. Thus, the upwardly protruding blade 21 acts centrifugally on a food product due to its arrangement when the upwardly protruding blade 21 chops a food product. The blade 21 protrudes from the cutting disc 17 further upwards than the downwardly protruding blade from the slot 18. Thus, thicker slices can be cut by the blade 21 than by the downwardly protruding blade.

If the chutes 6 end on the upper side of the cutting disc 17 shown in FIG. 5, the hood-shaped cutting elements 19 and the blade 21 can cut fed food products. The cutting directions of the blade 21 and the hood-shaped cutting elements 19 are oriented in opposite directions. The hood-shaped cutting elements 19 chop a fed food product in a strip-like manner when the cutting disc 17 is rotated clockwise. The blade 21 chops a fed food product in a disc-shaped manner when the cutting disc 17 is rotated counterclockwise. Depending on the direction of rotation of the cutting disc 17, a fed food product can thus be chopped either by the blade 21 in a disc-shaped manner or by the cutting elements 19 in a strip-shaped manner. By chopping, the chopped food product passes the slot below the blade 21 or the holes below the arcuate cutting elements 19 and thus the cutting disc 17, falls down and is not further chopped by the cutting device.

A shaft 22 is detachably attached to the cutting disc 17. The shaft 22 is shaft-shaped, at least partially hollow and has wreath-shaped coupling elements 23 at its ends. The above-mentioned rod 10 can be inserted through the upper coupling element 23 into the shaft of the shaft 22. This stabilizes the position of the shaft 22 during operation in the assembled state of the cutting device, The coupling elements 23 have the same shape. The shaft 22 protrudes equally far from both sides of the cutting disc 17. The cutting disc can therefore also be mounted rotated by 180° so that the chutes 6 then enter at the lower side shown in FIG. 5, In this case, the downwardly protruding blade or the downwardly protruding hood-shaped cutting elements can chop a food product in principle as described above, but not the upwardly protruding blade 21 or the upwardly protruding hood-shaped cutting elements 19 in the case of FIG. 5.

The described centrifugal action contributes to stabilize the orientation of a food product during feeding.

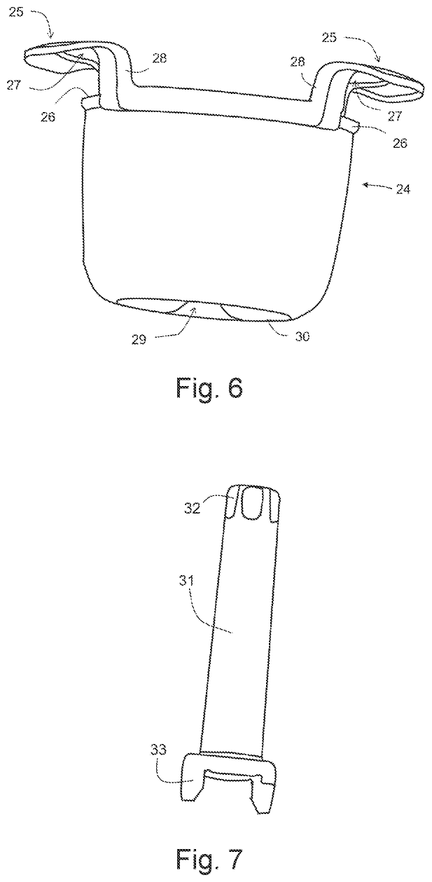

FIG. 6 shows a vessel 24 of the cutting device in which a chopped food product is collected after passing through the cutting disc 17. On the upper side of the vessel 24, there are two opposing handles 25. The two handles 25 extend from upper edge portions 26 of the vessel 24, first upwardly and then outwardly to the side. In this manner, each handle 25 forms an opening 27, and the aforementioned steps 8 can be inserted into the openings 27. The lower sides of the steps 8 are then seated on the edge portions 26. The upwardly facing ridges 28 of the handles 25 then prevent lateral sliding of the cover 5 with the cap 7 and contribute to positioning of the cover 5. The hook shapes 13 of the lower sides can then engage around the edge portions 26, and thus complementarily help to position the cover 7 relative to the vessel 24 and prevent lateral sliding,

The bottom 30 of the vessel 24 has a funnel-shaped opening 29 that opens into a hollow shaft.

In FIG. 7, a shaft 31 is shown which can be inserted through the funnel-shaped opening 29 and the adjoining hollow shaft, The upper end of the shaft 31 has a coupling element 32 which can be inserted into the lower coupling element 23 of the cutting disc 17. The outer contour of the coupling element 32 corresponds to the inner contour of the coupling element 23. This ensures that the two coupling elements are connected to each other in a rotationally fixed manner when the coupling element 32 is inserted into the coupling element 23.

The shaft 31 has a lower coupling element 33. The lower coupling element 33 can be placed on a mixing tool inside a preparation vessel of a food processor in such a way that the coupling element 33 is connected to the mixing tool in a rotationally fixed manner. Rotation of the mixing tool then results in the cutting disc 17 also being rotated when the shaft 31 is connected to the cutting disc 17 in a rotationally fixed manner.

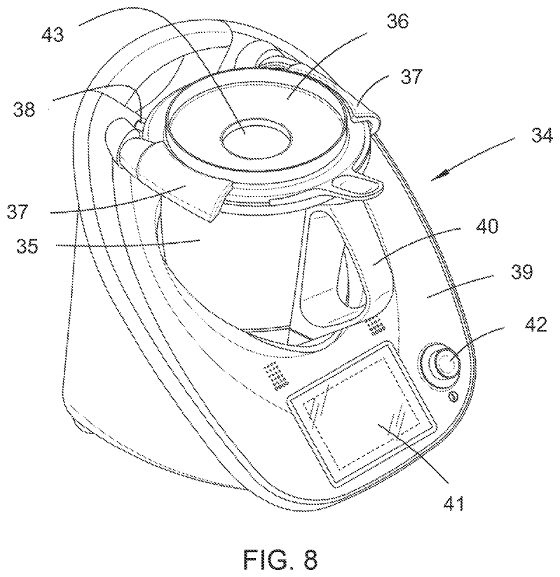

FIG. 8 shows a food preparation appliance, namely a food processor 34 with a preparation vessel 35. A lid part 36 is placed on the preparation vessel 35. The lid part 36 for the preparation vessel 35 is locked by arm-like locking elements, i.e. arms 37. The lid part 36 is located between the two arms 37. The arms 37 can be rotated about their longitudinal axis in a motorized manner to reciprocate between an open position and a locking position. The lid part 36 has pushed down and thus triggered a sensor. namely a rocker 38 of an electrical switch. The arm-like locking members 37 and the rocker 38 are attached to a base part 39 of the food processor 34. The preparation vessel 35 is inserted into the base part 39 and can be removed from the base part 39. In order to be able to remove the preparation vessel 35, this comprises a handle 40. The base part 39 comprises a display 41 and a rotary switch 42 for operation. The lid part 36 comprises an opening 43 in the center, which can be closed with a vessel-like closure. As a result of the triggered rocker 38, the control unit of the food processor 34 has received information that the lid part 36 is properly placed and locked, However, the control unit of the food processor 34 has not been able to obtain information about the state of the vessel-like closure which is not shown.

When the arrn-type locking elements 37 are rotated to their open position, this causes the rocker 38 to move upward by spring force to its non-released position. This movement of the rocker 38 raises the lid part 36 accordingly. The lid part 36 is then placed on the rocker arm 38, but not locked.

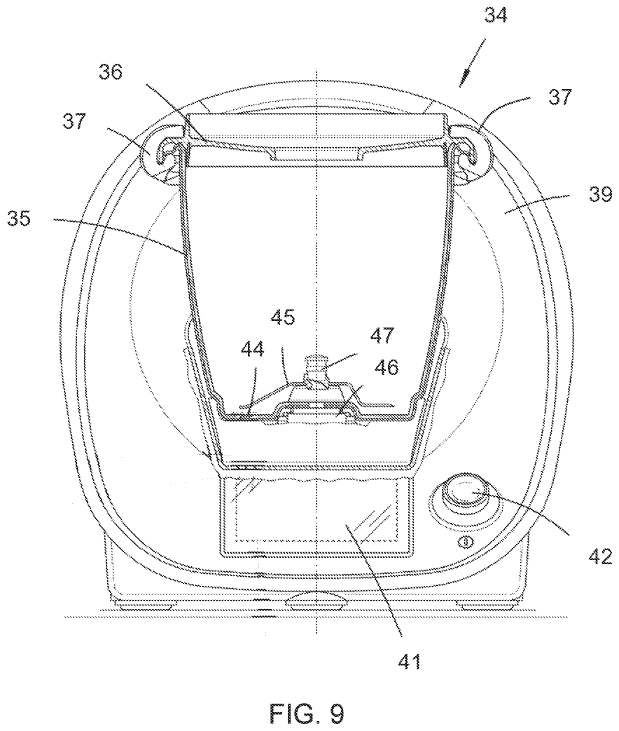

FIG. 9 shows the food processor 34 of FIG. 8. The region of the preparation vessel 35 is shown cut open to reveal the interior. A rotatable mixing tool 45 is located at the base 44 of the preparation vessel 35. The mixing tool 45 is driven by a shaft 47 which extends through the base 44 of the preparation vessel 35. The shaft 47 is inserted with a lower coupling element into a coupling element 46 of the base part 39 and thereby connected in a rotationally fixed manner. The coupling element 46 is connected to the shaft of an electric motor located in the base part 39. The mixing tool 45 can be rotated via the electric motor in the base part 39.

When the locking element 37 shown in the upper left of FIG. 9 is rotated counterclockwise and the locking element 37 shown in the upper right is rotated clockwise, the lock is released and the lid part 36 can be removed from the preparation vessel 35.

The coupling element 33 shown in FIG. 7 can be placed on the shaft 47 such that a rotationally fixed connection is established between the mixing tool 45 and the coupling element 33.

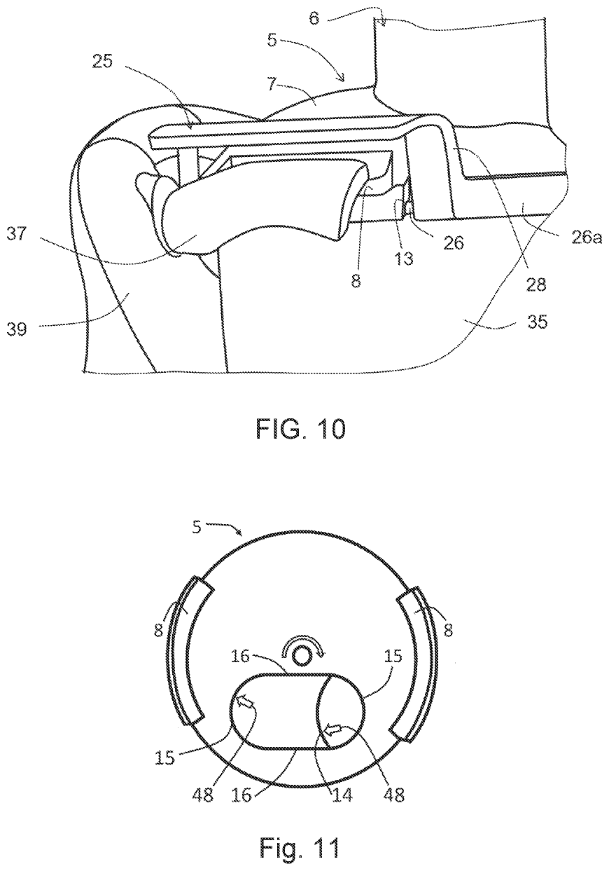

Instead of the lid part 36, the cutting device can be placed on the preparation vessel 35. This is shown partially in FIG. 10 in the locked position. The locking element 37 rests on the step 8 of the cover 5 in such a way that the cover 5 can no longer be detached from the preparation vessel 35 as a result. The cover 5 rests on the upper edge 26 of the vessel 24. As a result, the vessel 24 cannot be removed from the preparation vessel 35. The rocker 38 is operated by a laterally protruding edge portion 26a of the vessel 24.

If the cutting device is placed on the preparation vessel 35 and the cutting disc 17 rotates clockwise as indicated by an arrow in FIG. 11, food products 48 are pressed against the partition 14 or against the end wail 15 as indicated and held in place by the curved path. The orientation of the respective food product 48 is thus stabilized. Very uniform chopping results are thus achieved.

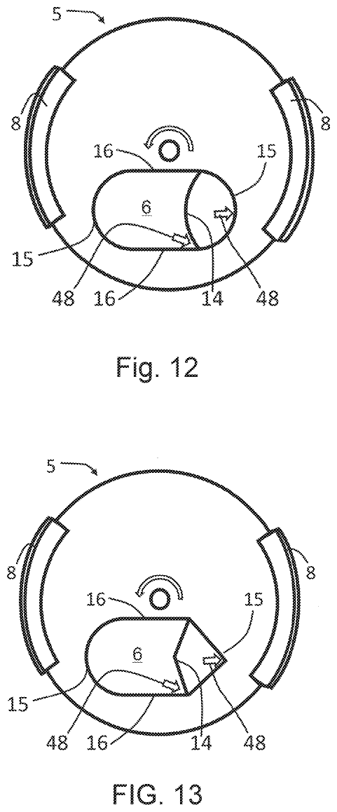

In FIG. 12, it is shown how food products 48 are held and their orientation is stabilized when the cutting disc 17 is rotated counterclockwise. This happens because the chutes 6 are located off-center. Seen from above, the chutes 6 are arranged next to the shaft 22 of the cutting disk 17. Food products fed to the cutting disc 17 by the chute 6 shown on the left are held as indicated by the angle formed by the partition 14 and the wall 16 at the outside of the cover 5. This angle is preferably 40° to 80°.

Independent of the direction of rotation and independent of the chute, food products can therefore always be fed to the cutting disc 17 in stable alignment for chopping.

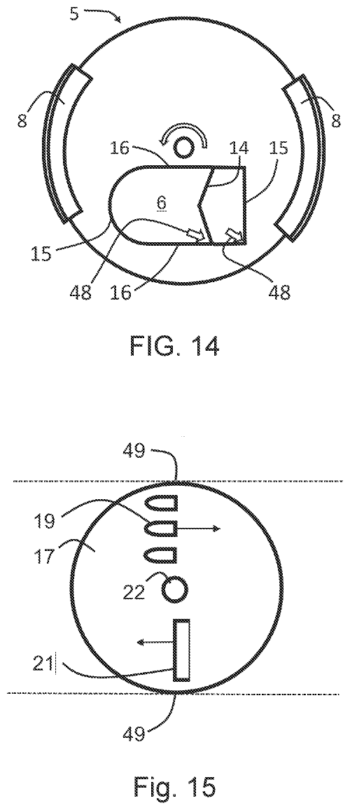

FIG. 14 illustrates that the position of a food product 48 can also be stabilized with the straight end wall 15 shown on the right, so that uniform chopping results can also be achieved with such an end wall 15. However, better results are achieved with an arcuate end wall 15.

FIG. 15 shows an example in which cutting elements 19, 21 are arranged and aligned in such a way that they do not convey a food product centrifugally in the direction of the adjacent outer side 49 of the cutting disc 17. Instead, the food product is conveyed parallel to the adjacent outer side 49 of the cutting disc 17 in the cutting direction, as indicated by arrows.

The filling neck and partition may have been produced in one piece in a single step, for example by injection molding. The filling neck and partition may consist of plastic in order to keep production costs and weight low. Each chute runs in particular in a straight line so that a food product can pass through each chute as unhindered as possible.

The partition comprises an indentation when viewed in plan view. Thus, the partition is not straight when viewed in plan view. The partition can be angular and/or arcuate in shape when viewed in plan view.

The indentation prevents a food product in a chute from changing its orientation in a largely unhindered manner. The aim of the indentation is therefore to ensure that the position of the food product changes as far as possible only in the direction of transport. It has been found that this allows a food product to be chopped particularly uniformly. Strongly varying chopping results can therefore be avoided.

The partition may be angular when viewed in plan view. The base of the indentation is then formed by an angle. Advantageously, however, the partition runs in an arcuate shape when viewed in plan view, whereby the alignment of a food product can be stabilized in the chute regardless of its size. This leads to uniform cutting results.

In one embodiment, the partition runs in a circular arc when viewed in plan view. Advantageously, the partition is therefore a partial circle when viewed in plan view in order to be able to chop uniformly in a further improved manner.

In one embodiment, the partition initially encloses an angle of 40° to 80° with at least one wall portion of the chute. Such an angle is particularly well suited to stabilize the orientation also of larger food products when feeding them to the cutting disc.

Preferably, the wall portion is an external wall portion to ensure uniform chopping results in a further improved manner.

In principle, the inlet openings of the chutes are of different sizes in order to be able to stably feed food products of different sizes to the cutting disc in an improved manner.

In one embodiment, the inlet opening of one chute is at least 1,5 times as large as the inlet opening of the other chute, preferably at least twice as large, in order to be able to feed food products of different sizes to the cutting disc in a stable orientation.

In one embodiment, the filling neck is oval when viewed in plan view, in order to be able to achieve the alignment of food products and thus a particularly uniform chopping result independently of the direction of rotation of the cutting disc.

For example, the oval can be composed of two circular arcs and two straight lines.

Advantageously, the two straight lines of the oval run parallel so that the chutes are uniformly wide, which facilitates insertion of a food product into one of the two chutes.

The two arcs are preferably semicircles to allow a smooth transition to parallel walls of the oval. The transition is then free of edges. Among other things, this allows cleaning advantages to be achieved. Semicircles also help to stabilize the alignment of food products particularly reliably during feeding, irrespective of the direction of rotation of the cutting disc.

The oval may be an oval with one or two symmetry axes.

In one embodiment, there is a motor for rotating the cutting disc to perform chopping in a partially automated manner.

In one embodiment, the cutting disc can be rotated both clockwise and counterclockwise by the motor. This makes it possible to achieve different chopping results depending on the direction of rotation.

In one embodiment. the cutting device comprises different cutting elements and/or friction elements.

In one embodiment, the different cutting elements and/or friction elements are oriented differently so that different chopping results can be achieved in a defined manner depending on the direction of rotation.

In one embodiment, the different cutting elements and/or friction elements protrude from both the lower side and the upper side of the cutting disc. The cutting elements and/or friction elements protruding from the lower side differ from the cutting elements and/or friction elements protruding from the upper side. It is possible to select which side faces the filling neck. The cutting disc can therefore be mounted in two different ways. Depending on the side selected, different cutting results can be achieved. If the upper side of the cutting disc faces the filling neck, only the cutting elements and/or friction elements that protrude from the upper side can chop. If, on the other hand, the lower side of the cutting disc faces the filling neck, only the cutting elements and/or friction elements that protrude from the lower side can chop.

With regard to the different cutting elements and/or friction elements, these elements are features that are independent of the indentation of the partition and can therefore be combined with the above-mentioned features independently of this indentation.

To make it particularly easy to select the side of the cutting disc that is to face the filling neck, the shaft is mirror-symmetrical, wherein the cutting disc forms the mirror plane. The shaft at least protrudes equally far from the upper side and the lower side of the cutting disc. If the shaft comprises coupling elements at its ends, these are then the same. This minimizes the assembly work required to mount the cutting disc. This is an independent feature which is independent of the indentation of the partition and can therefore be combined with the above-mentioned features independently of this indentation.

In one embodiment, cutting elements and/or friction elements are arranged or aligned in such a way that they convey a food product centrifugally towards the adjacent outer side of the cutting disc. Thus, there is no conveying parallel to the adjacent outer side of the cutting disc. This stabilizes the orientation of a food product during chopping, which has an effect independently of the indentation of the partition and thus also constitutes an independent feature. In order to develop a centrifugal effect, a cutting edge, viewed in the cutting direction, can enclose an angle smaller than 90°, preferably smaller than 85°, particularly preferably smaller than 80°, with the adjacent outer side of the cutting disc. Alternatively or additionally, cutting elements located on the outside can be arranged offset backwards relative to cutting elements located on the inside, namely in the cutting direction, in order to achieve the desired centrifugal effect. Alternatively or additionally, cutting elements can be arranged in a row in such a way that the row, viewed in the cutting direction, encloses an angle smaller than 90°, preferably smaller than 85°, particularly preferably smaller than 80′, with the adjacent outer side, in order to achieve a centrifugal effect.

In one embodiment, the cutting device comprises a pressing means that can be inserted into the filling neck in order to press food products through the chutes. In particular, the pressing means comprises two plungers which may be non-detachably connected to one another on the upper side. The pressing means may have been produced in one piece from plastic in one work step.

Preferably, the pressing means can be inserted into the filling neck such that the pressing means is held in a clamping manner when the pressing means has been fully inserted into the filling neck. Initially, there is advantageously no clamping effect, so that the pressing means can initially be inserted into the filling neck easily. Thus, the pressing means can advantageously not fall out of the filling neck in an unplanned manner once a food product has been chopped in the maximum possible way. This is an independent feature which is independent of the indentation of the partition and can therefore be combined with the above-mentioned features independently of this indentation.

A clamping effect can be achieved by a slot between two plungers of the pressing means that widens towards the outside and the partition finally being held in a clamping manner by the slot when the pressing means has been fully inserted into the filling neck. Another possibility consists in a chute tapering inwards in such a way that it holds a plunger in a clamping manner when the pressing means has been fully inserted into the filling neck.

In one embodiment, the cutting device is a part of a kitchen appliance or an accessory (add-on part) for a kitchen appliance. The kitchen appliance is in particular a food preparation appliance, with which, thus, a food can be prepared.

A food preparation appliance is an electrical appliance, i.e., an appliance that requires electrical power to operate. A food preparation appliance is an appliance with which at least one step of a food preparation can be performed, such as mixing, chopping, moistening, drying, cooling or heating. Thus, by the food preparation appliance, a food or at least one ingredient of a food can be mixed, chopped, moistened, dried, cooled, and/or heated, for example. A food may be solid and/or liquid. A food may comprise only one food product such as only potatoes. A food may be composed of various ingredients such as carrots, peas, onions, salt and pepper. A food may comprise a liquid such as water or oil.

A food preparation appliance comprises a preparation vessel and, in principle, a lid that can be placed on the preparation vessel. A rotatable mixing tool may be arranged in the preparation vessel. The food preparation appliance may comprise the cutting device as an accessory that can be placed on the preparation vessel instead of the lid, for example. The food preparation appliance may comprise a locking device for locking the lid placed on the preparation vessel and/or for locking the accessory placed on the preparation vessel. The food preparation appliance may comprise a sensor that is triggered when the lid placed on top is locked by the locking device and/or by the accessory placed on top.

Ingredients of a food that are placed directly in the preparation vessel can, for example, be chopped by the rotatable mixing tool. The mixing tool may rotate for this purpose, for example, at at least 5000 or at least 8000 rpm by means of an electric motor. The preparation vessel may comprise heating elements to be able to heat ingredients of a food or a food in the preparation vessel. However, the food preparation appliance may also comprise heating elements for heating the preparation vessel, which are provided separately from the preparation vessel. A base part of the food preparation appliance may comprise a recess that may define the position of the preparation vessel. The recess may be a vessel-like depression into which the preparation vessel may be or is inserted. The receptacle may comprise a drain opening that prevents liquid from accumulating in the recess. In particular, the preparation vessel may be removed from the recess and thus separated from the base part of the food preparation appliance.

The preparation vessel comprises an opening. The lid can be placed on the preparation vessel in such a way that the opening is then covered by the lid at least predominantly, preferably completely.

The accessory differs from the lid in its function. The function of the lid consists in being able to completely or at least largely completely close the preparation vessel. The accessory also contributes to the preparation of a food product in at least another way, since a food product can be uniformly and thus in a defined manner chopped by the accessory. However, the accessory can also assume the function of a lid at the same time, i.e. cover the opening of the preparation vessel at least predominantly. The accessory is therefore also a lid.

A base part of the food preparation appliance may comprise the locking device, which can non-detachably connect the lid and the accessory to the preparation vessel in the locked state. If the food preparation appliance is designed in such a way that the preparation vessel can be detached from the base part, the placing of the lid or the placing of the accessory on the preparation vessel according to the present disclosure requires that the preparation vessel is inserted into the base part. The preparation vessel is then inserted into a recess of the base part, for example.

The base part may comprise a control device, an electric actuator, a sensor, a switch, andior a display.

The device of the present disclosure enables food products to be chopped very uniformly, which is achieved by the indented partition and/or by the centrifugal effect described. Knobs at the pressing means support the stable alignment and thus make a supplementary contribution to uniform chopping. Two chutes of different sizes allow food products of different sizes to be fed in a stable alignment and thus chopped particularly uniformly. Four different cutting elements allow four different chopping results with only one cutting disc. The number of components required is low,

The present disclosure also relates to a component with a filling neck. The filling neck comprises two chutes which are separated by a partition. A food product can be fed to a cutting disc via each chute. The partition comprises an indentation when viewed in plan view. The component may be a cover. The component may be configured as previously described. The component may comprise features of the cover described below, individually or in combination.

1. A cutting device for chopping food products, the cutting device comprising:
a cutting disc including friction and/or cutting elements,
a shaft for the cutting disc, wherein the cutting disc is attached to the shaft or can be detachably attached to the shaft, and
a filling neck, via which food products can be fed to the cutting disc, wherein the filling neck comprises two chutes which are separated from one another by a partition, wherein each chute is suitable for feeding a food product to the cutting disc, and wherein the partition comprises an indentation when viewed in plan view.

2. The cutting device of claim 1, wherein the partition is arcuate when viewed in plan view.

3. The cutting device of claim 2, wherein the partition initially encloses an angle of 40° to 80° with at least one wall portion of the chute.

4. The cutting device of claim 1, wherein inlet openings of the chutes are of different sizes.

5. The cutting device of claim 1, wherein the cutting disc is rotatable both clockwise and counterclockwise by a motor of the cutting device.

6. The cutting device of claim 1, wherein the cutting disc comprises at least two, preferably at least four, different cutting elements and/or different friction elements.

7. The cutting device of claim 1, wherein the different cutting elements are oriented differently so that different chopping results can be achieved in a defined manner depending on the direction of rotation.

8. The cutting device of claim 1, wherein the cutting elements and/or friction elements protrude from both a lower side and an upper side of the cutting disc, and wherein it is possible to select which side of the cutting disc faces the filling neck, so that different chopping results can be achieved in a defined manner depending on the selected side.

9. The cutting device of claim 8, wherein the shaft protrudes equally far from the upper side and the lower side of the cutting disc.

10. The cutting device of claim 1, wherein the shaft comprises identical coupling elements at its ends.

11. The cutting device of claim 1, wherein the cutting elements and/or friction elements of the cutting disc are arranged or aligned in such a way that they centrifugally convey a food product towards an adjacent outer side of the cutting disc.

12. The cutting device of claim 1, further comprising a pressing means insertable into the filling neck such that the pressing means is held in a clamping manner, and/or wherein the pressing means comprises plungers which have knobs on their underside.

13. A component comprising:
a filling neck via which food products are fed to a cutting disc of a cutting device, wherein the filling neck comprises two chutes separated from one another by a partition, wherein each chute is suitable for feeding a food product to the cutting disc, and wherein the partition comprises an indentation when viewed in plan view.

14. The component of claim 13, wherein the partition is arcuate.

15. The component of claim 13, wherein inlet openings of the chutes are of different sizes.

16. The component of claim 13, wherein the component is a cover and the two chutes are located next to the center of the cover.

17. A food preparation appliance for chopping food products, the food preparation appliance comprising:
a cutting disc including a plurality friction and/or cutting elements;
a shaft configured to receive the cutting disc; and
a filling neck portion defining two chutes for transferring food products to the cutting disc, wherein the chutes are separated from one another by a partition, and wherein, in a plan view, the partition comprises an indentation.

18. The food preparation appliance of claim 17, wherein each chute is configured to receive a corresponding plunger, and wherein the plungers are interconnected with one another.

19. The cutting device of claim 1, wherein the two chutes are arranged off-center with respect to the shaft.

20. The cutting device of claim 13, wherein the two chutes are arranged off-center with respect to the shaft in such a manner that food can be pressed against the partition by the cutting disk when the cutting disk is attached to the shaft and the cutting disk is rotating.
